(19) United States
(12) Patent Application Publication
(10) Pub. No.: US 2004/0249978 A1
(43) Pub. Date: Dec. 9, 2004

(54) Method and apparatus for customizing a Web page

(75) Inventors: Kumar Marappan, Round Rock, TX (US); Kanmani Nachimuthu, Austin, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/455,185

(22) Filed: Jun. 5, 2003

(51) Int. Cl. G06F 15/16

(52) U.S. Cl. 709/246

(57) ABSTRACT

A method, apparatus, and computer instructions for customizing information in a Web page. The Web page is received and includes a set of selected tags used to enable customization of selected information in the Web page. Responsive to a selection of the selected information in the Web page, a graphical user interface is presented to customize the selected information. New information is received through the graphical user interface. Responsive to receiving the new information, all instances of selected information in the Web page are modified to reflect the new information.

### BACKGROUND OF THE INVENTION

1. Technical Field

The present invention relates generally to an improved data processing system and in particular to a method and apparatus for processing data. Still more particular, the present invention relates to a method, apparatus, and computer instructions for customizing documents.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely employed to transfer applications to users using browsers. With respect to commerce on the Web, individual consumers and business use the Web to purchase various goods and services. In offering goods and services, some companies offer goods and services solely on the Web while others use the Web to extend their reach.

Users exploring the Web have discovered that the content supported by HTML document format on the Web was too limited. Users desire the ability to access applications and programs, but applications were targeted towards specific types of platforms. As a result, not everyone could access applications or programs. This deficiency has been minimized though the introduction and use of programs known as “applets”, which may be embedded as objects in HTML documents on the Web. Applets are Java programs that may be transparently downloaded into a browser supporting Java along with HTML pages in which they appear. These Java programs are network and platform independent. Applets run the same way regardless of where they originate or what data processing system onto which they are loaded.

Oftentimes, users may come across Web pages with instructions for installing software. These instructions may often refer to some arbitrary location or path on a computer. The user viewing this page is expected to retype the entire folder location or copy and paste the location from the instruction on the Web page into the computer and then change this location to the appropriate name. Having to retype the folder location entirely or cutting and pasting it and then modifying the location can be frustrating and time consuming especially if it involves a lot of similar edits.

Therefore, it would be advantageous to have an improved method, apparatus, and computer instructions for customizing a Web page, especially with respect to location information.

### SUMMARY OF THE INVENTION

The present invention provides a method, apparatus, and computer instructions for customizing information in a Web page. The Web page is received and includes a set of selected tags used to enable customization of selected information in the Web page. Responsive to a selection of the selected information in the Web page, a graphical user interface is presented to customize the selected information. New information is received through the graphical user interface. Responsive to receiving the new information, all instances of selected information in the Web page are modified to reflect the new information.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram of components used to customize Web pages in accordance with a preferred embodiment of the present invention;

FIGS. 4A-4C are diagrams illustrating customization of a Web page in accordance with a preferred embodiment of the present invention;

FIG. 5 is a flowchart of a process for receiving user input containing customization information in accordance with a preferred embodiment of the present invention; and

FIG. 6 is a flowchart of a process for customizing a Web page in accordance with a preferred embodiment of the present invention.

### DETAILED DESCRIPTION OF THE PREFERRED EMBODIMENT

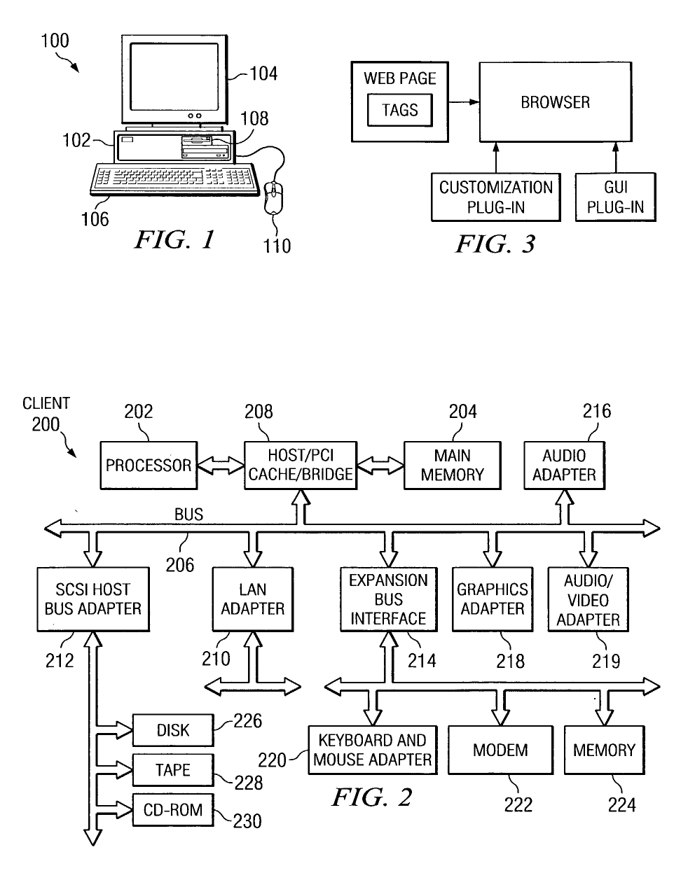

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention recognizes that no mechanism is present to allow highlighting a portion of text in a Web page, customize text in the Web page at that point, and then use the information from the Web page. The present invention provides a method, apparatus, and computer instructions for customizing Web pages with respect to information in the Web page.

The mechanism of the present invention provides a customization functionality in Web pages, both static and dynamic, through the use of tags, such as anchor tags, to enable plug-ins. The mechanism of the present invention includes a plug-in in a Web browser to allow presentation of a graphical user interface to receive customization information for a Web page. The present invention also includes a plug-in that finds and replaces information similar to that selected for customization. This plug-in may recursively modify the Web page to customize all occurrences of the information selected for customization.

Turning now to FIG. 3, a diagram of components used to customize Web pages is depicted in accordance with a preferred embodiment of the present invention. Browser 300 processes and displays Web page 302 on a display on a data processing system, such as data processing system 200 in FIG. 2. A browser is an application used to navigate or view information or data in a distributed database, such as the Internet or the World Wide Web. Browser 300 may be implemented using known browser applications, such as Netscape Navigator or Microsoft Internet Explorer. Netscape Navigator is available from Netscape Communications Corporation while Microsoft Internet Explorer is available from Microsoft Corporation.

Tags 304 in Web page 302 allow for GUI plug-in 306 and customization plug-in 308 to be enabled. A plug-in is an auxiliary program that works with another program, such as browser 300 to enhance the capability of that program. For example, plug-ins are commonly added to Web browsers to enable those browsers to support new types of content, such as audio and video. In this example, GUI plug-in 306 and customization plug-in 308 are used to enhance browser 300 to allow for customization of content in Web page 302.

When a user views Web page 302, the user may highlight text for customization. The customization features may be initiated through a user input, such as a right click on a mouse button. This feature is provided in response to the user input if appropriate tags, such as tags 304 are present in Web page 302. In these examples, tags 304 are anchor tags and also are referred to as customization tags. In these examples, tags 304 are placed around text or information that is intended to be customizable by the user. The tags are placed only where the customization feature is needed in these examples. The tags may be for example, HTML tags that are recognized by the plug-ins. Alternatively, custom tags recognized by the plug-ins may be used.

This user input initiates display of a text box with the current information, such as location information within a text box. This text box is displayed in the location of the selected information in these examples. At that point, a user may customize this location information to suit the needs of the user. This type of interface is provided by GUI plug-in 306 in this example. After the location information has been customized, customization plug-in 308 may change this information recursively throughout Web page 302.

Another feature of the present invention is that the customized information is not stored, such that the original content of the Web page is unaltered. This mechanism may be implemented in any currently available browser through the use of plug-ins. Further, although the examples illustrate two plug-ins, the mechanism of the present invention may be implemented in other ways. For example, a single plug-in may be used or, depending on the implementation, code within the browser may be modified to include this feature.

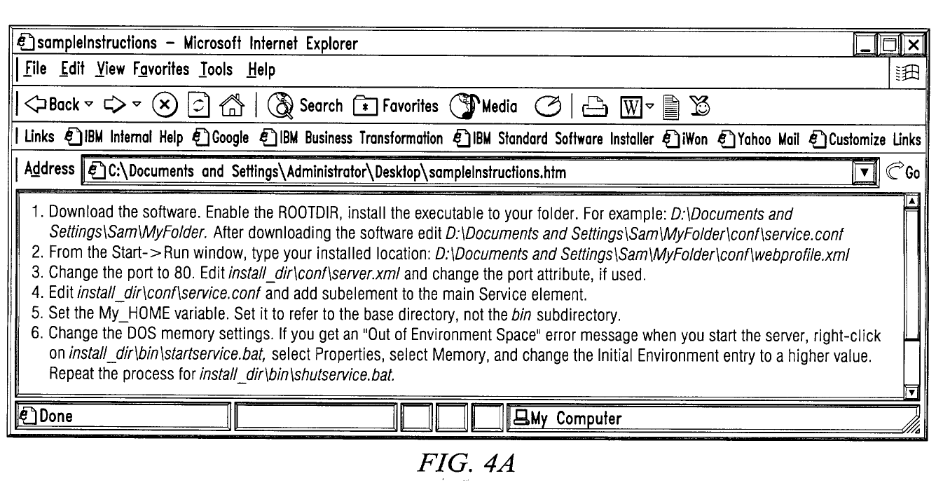

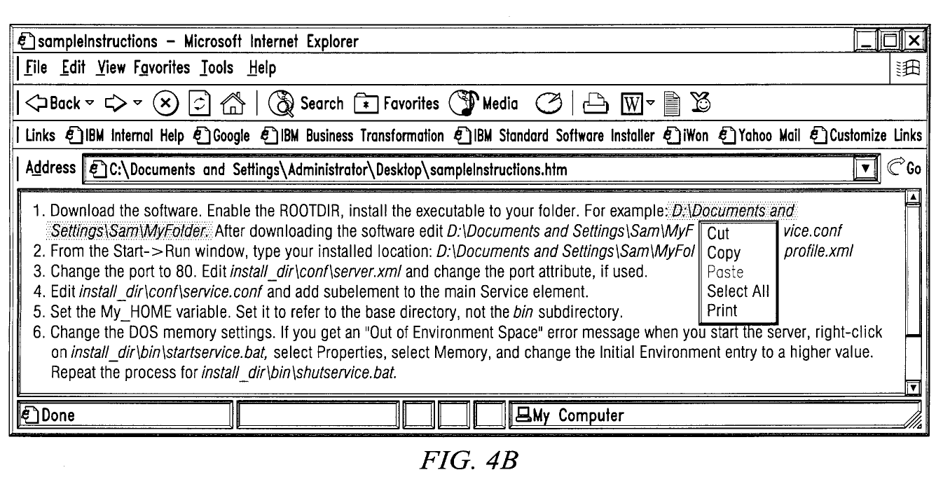

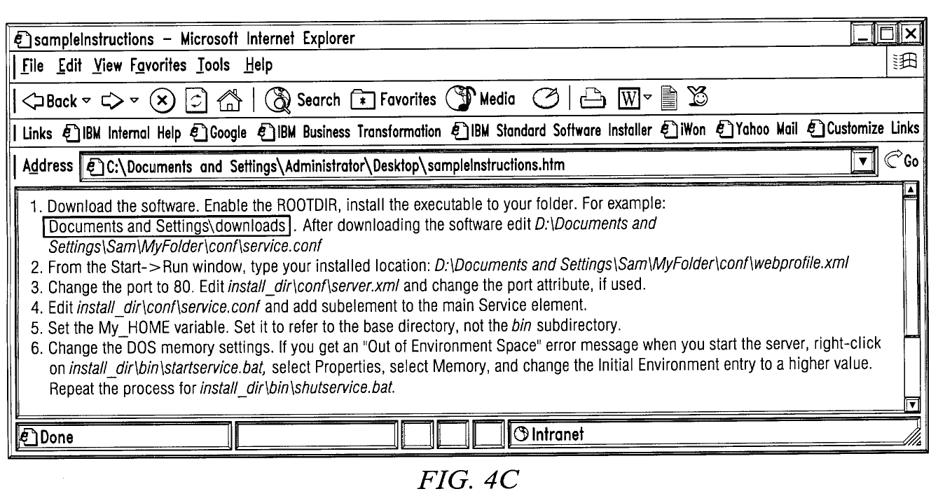

Turning next to FIGS. 4A-4C, diagrams illustrating customization of a Web page are depicted in accordance with a preferred embodiment of the present invention. In FIG. 4A, Web browser 400 displays Web page 402. As illustrated, Web page 402 provides information about a software installation process.

In FIG. 4B, directory description 404 containing a path is illustrated in which the user has highlighted this description and right clicked to display menu 406. In this example, menu 406 includes customize option 408. Selection of customize option 408 opens up text field 410 in FIG. 4C. This text field allows a user to edit the content to provide the appropriate customization, such as the location or path desired by the user. Thereafter, the user may, through another user input, such as the right click of a mouse or the selection of a command from a menu bar, find and replace similar content within Web page 402.

In this manner, the mechanism of the present invention provides a convenient feature for customizing information in a Web page. Further, this feature allows for customization of information in Web page 402 and having that customized information propagated throughout the Web page. In other words, other instances in which the same original location is found elsewhere in Web page 402 is changed to reflect the customized information entered by the user.

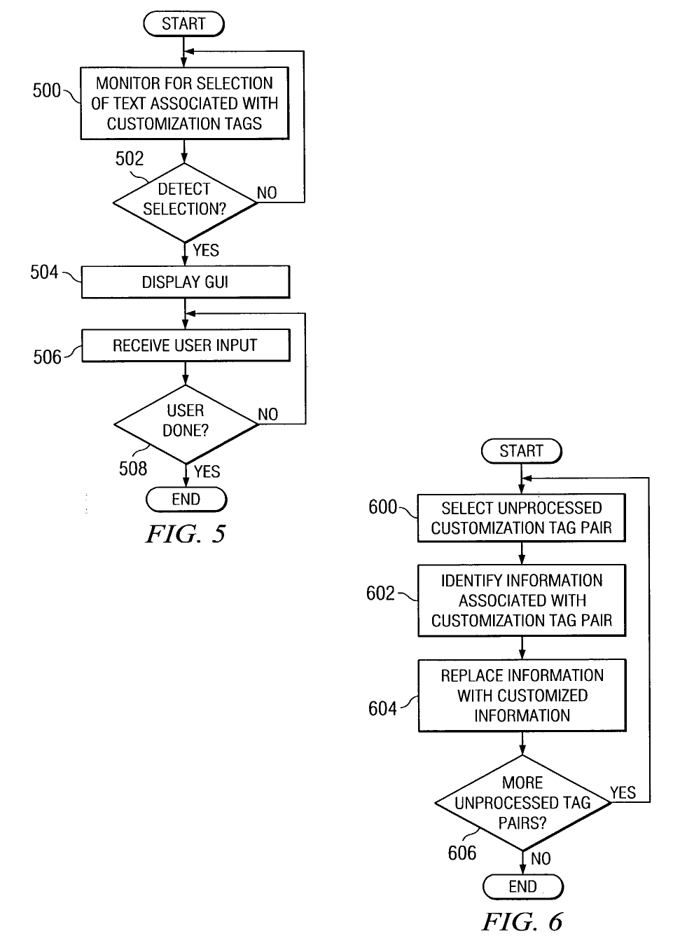

Turning now to FIG. 5, a flowchart of a process for receiving user input containing customization information is depicted in accordance with a preferred embodiment of the present invention. In this example, the process illustrated in FIG. 5, may be implemented in a plug-in, such as GUI plug-in 306 in FIG. 3.

The process begins by monitoring for selection of text associated with customization tags (step 500). These customization tags, may be tags, such as tags 304, as described in FIG. 3. Next, a determination may be made as to whether selection of this type of text has been selected (step 502). If selection of this text has not been detected, the process returns to step 500.

Otherwise a GUI is displayed to receive user input to customize the selected text (step 504). In this example, the GUI takes the form of a text input field displayed in the Web page at the location of the selected text. Thereafter, user input is received into the text input field (step 506). In step 506, with location information, this input may take the form of a new path or location or a modification of the original path or location in the Web page. Then, a determination is made as to whether the user is done entering customizations (step 508).

If the user has finished inputting customizations, the process terminates. Otherwise the process returns to step 506 to receive additional user input.

Turning now to FIG. 6, a flowchart of a process for customizing a Web page is depicted in accordance with a preferred embodiment of the present invention. The process illustrated in FIG. 6 may be implemented in a plug-in, such as customization plug-in 308 in FIG. 3.

The process begins by selecting an unprocessed customization process tag pair (step 600). This tag pair is a set of tags that surrounds text that has not been customized with the information input by the user through the process described for the flowchart in FIG. 5. Thereafter, information associated with the customization pair is identified (step 602). Thereafter, this information is replaced with the customized information (step 604). A determination is then made as to whether unprocessed customization tag pairs are present (step 606).

If other unprocessed customization tag pairs are present, the process returns to step 600. Otherwise, the process terminates. In this manner, the process may replace all instances of the information selected for customization without requiring the user to select each instance of this information.

Thus, the present invention provides a method, apparatus, and computer instructions for customizing Web pages. The mechanism of the present invention provides a time saving feature for use in looking up information in Web pages and using this information. In these examples, this feature is used with respect to location information in a software installation process. These features are enabled through the tags and plug-ins described above.

The mechanism of the present invention also is useful for disabled persons to allow for information to be customized in one place in the Web page and having those customizations being propagated or reflected in other places. Additionally, this customized information is not saved, avoiding altering the original Web page and violating standards for Web pages.

As a result, with the current invention, the user can edit the specifics in a web page with the help of the enabled plug-in that recognizes the specifics and recursively makes changes throughout the document if necessary and can copy and paste the edited information without having to re-edit and retype all over again.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. In these examples, the information customized is location information, such as a path in a data processing system. The mechanism of the present invention is not limited to only location information, it may be applied to other types of information. Any information can be customized. For example, URL information and application forms may benefit from the customization features of the present invention. Also, since the data is not being saved into a system, there is no privacy or copyright issues. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for customizing location information in a Web page, the method comprising:
receiving a Web page, wherein the Web page includes a set of selected tags used to enable customization of locations in the Web page;
responsive to a selection of a location in the Web page, providing a graphical user interface for use in customizing the location;
receiving a new location through the graphical user interface; and
responsive to receiving the new location, modifying the locations to reflect the new location.

2. The method of claim 1, wherein the providing step is implemented in a plug-in associated with a Web browser used to display the Web page.

3. The method of claim 2, wherein the modifying step is implemented in another plug-in.

4. The method of claim 1, wherein the location is a path to a location in the data processing system.

5. A method in a data processing system for customizing of selected information in a Web page, the method comprising:
receiving a Web page, wherein the Web page includes a set of selected tags used to enable customization of the selected information in the Web page;
responsive to a selection of the selected information in the Web page, providing a graphical user interface to receive customized information;
responsive to receiving the customized information through the graphical user interface, replacing each instance of the selected information with the customized information.

6. The method of claim 5, wherein the customized information is a location in the data processing system.

7. The method of claim 5, wherein the customized information is a path to a folder in the data processing system.

8. A Web browser comprising:
a first set of instructions for displaying a graphical user interface allowing entry of a location in response to a selected user input and a presence of a selected set of tags in a Web page displayed by the Web browser; and
a second set of instructions for modifying locations in the Web page in response to entry of the location.

9. A data processing system for customizing location information in a Web page, the data processing system comprising:
receiving means for receiving a Web page, wherein the Web page includes a set of selected tags used to enable customization of locations in the Web page;
providing means, responsive to a selection of a location in the Web page, for providing a graphical user interface for use in customizing the location;
receiving a new location through the graphical user interface; and
responsive to receiving the new location, modifying the locations to reflect the new location.

10. The data processing system of claim 9, wherein the providing means is implemented in a plug-in associated with a Web browser used to display the Web page.

11. The data processing system of claim 10, wherein the modifying means is implemented in another plug-in.

12. The data processing system of claim 9, wherein the location is a path to a location in the data processing system.

13. A data processing system for customizing of selected information in a Web page, the data processing system comprising:
receiving means for receiving a Web page, wherein the Web page includes a set of selected tags used to enable customization of the selected information in the Web page;
providing means, responsive to a selection of the selected information in the Web page, for providing a graphical user interface to receive customized information;
replacing means, responsive to receiving the customized information through the graphical user interface, for replacing each instance of the selected information with the customized information.

14. The data processing system of claim 13, wherein the customized information is a location in the data processing system.

15. The data processing system of claim 13, wherein the customized information is a path to a folder in the data processing system.

16. A data processing system comprising:
a bus system;
a memory connected to the bus system, wherein the memory includes a set of instructions; and
a processing unit connected of the bus system, wherein the processing unit executes the set of instructions to receive a Web page, wherein the Web page includes a set of selected tags used to enable customization of locations in the Web page; provides a graphical user interface for use in customizing the location in response to a selection of a location in the Web page; receives a new location through the graphical user interface; and modifies the locations to reflect the new location in response to receiving the new location.

17. A data processing system comprising:
a bus system;
a memory connected to the bus system, wherein the memory includes a set of instructions; and
a processing unit connected the bus system, wherein the processing unit executes the set of instructions to receive a Web page, wherein the Web page includes a set of selected anchor tags used to enable customization of the selected information in the Web page; provides a graphical user interface to receive customized information in response to a selection of the selected information in the Web page, replaces each instance of the selected information with the customized information in response to receiving the a customized information through the graphical user interface.

18. A computer program product in a computer readable medium for customizing location information in a Web page, the computer program product comprising:
first instructions for receiving a Web page, wherein the Web page includes a set of selected tags used to enable customization of locations in the Web page;
second instructions, responsive to a selection of a location in the Web page, for providing a graphical user interface for use in customizing the location;
third instruction for receiving a new location through the graphical user interface; and
fourth instruction, responsive to receiving the new location, for modifying the locations to reflect the new location.

19. A computer program product in a computer readable medium for customizing of selected information in a Web page, the computer program product comprising:
first instructions for receiving a Web page, wherein the Web page includes a set of selected tags used to enable customization of the selected information in the Web page;
second instructions, responsive to a selection of the selected information in the Web page, for providing a graphical user interface to receive customized information;
third instruction, responsive to receiving the customized information through the graphical user interface, for replacing each instance of the selected information with the customized information.
